(19) United States
(12) Patent Application Publication
(10) Pub. No.: US 2019/0246674 A1
(43) Pub. Date: Aug. 15, 2019

(54) Blending System for Amino Acid Nitrogen Value Adjustment for Soy Sauce

(71) Applicant: Lee Kum Kee (Xin Hui) Food Co., Ltd., Jiangmen (CN)

(72) Inventors: Gang Wang, Jiangmen (CN); Zhuobin Zhong, Jiangmen (CN)

(73) Assignee: Lee Kum Kee (Xin Hui) Food Co., Ltd., Jiangmen (CN)

(21) Appl. No.: 16/144,663

(22) Filed: Sep. 27, 2018

(30) Foreign Application Priority Data
Feb. 12, 2018 (CN) 201810147285X

(51) Int. Cl. A23L 27/50; A23L 33/105; A23L 27/24

(52) U.S. Cl. CPC A23L 27/50; A23V 2002/00; A23L 27/24; A23L 33/105

(57) ABSTRACT

A blending system for amino acid nitrogen value adjustment for soy sauce, comprising: a first soy-sauce tank configured to receive first extracted soy sauce and provided with a first circulation loop, and a second soy-sauce tank configured to receive second extracted soy sauce and provided with a second circulation loop; wherein, each of the first circulation loop and the second circulation loop is provided with an ammonia-nitrogen-value detection apparatus, and each of the first soy-sauce tank and the second soy-sauce tank is provided with an output tube with an output control valve connected to the amino acid nitrogen value detection apparatus, the output tubes of the first soy-sauce tank and the second soy-sauce tank are jointed and connected to a tube mixer. The blending system of the invention is fully-automatic and intelligent, resulting in improved production efficiency.

### CROSS REFERENCE TO RELATED APPLICATIONS

This application claims priority from Chinese Patent Application No. 201810147285X, filed on Feb. 12, 2018. Entitled “Blending System for Amino Acid Nitrogen Value Adjustment for Soy Sauce”, the content of which is incorporated by reference herein in their entirety.

### TECHNICAL FIELD

The present invention relates to the field of soy sauce production, and in particular, to a blending system for amino acid nitrogen value adjustment for soy sauce.

### BACKGROUND

In the production process of soy sauce, a fermentation step a required, which generally comprises two sub-steps: in the first sub-step, raw materials are fermented for three months to obtain first extracted soy sauce; in the second sub-step, the raw materials, from which the first extracted soy sauce has been obtained through fermentation, are added with salt and then fermented for 15 more days to obtain second extracted soy sauce. Soy sauce ingredients in the raw materials are fully released during the two fermentation processes. In general, the first extracted soy sauce obtained by the above fermentation step has an amino acid nitrogen value slightly higher than 0.8, while the second extracted soy sauce has an amino acid nitrogen value around 0.5-0.6. However, a suggested amino acid nitrogen value for regular soy sauce ranges from 0.7 to 0.75. Therefore, it is necessary to adjust the amino acid nitrogen values of both the first extracted soy sauce and the second extracted soy sauce for providing finished soy sauce that satisfies the requirements. However, in the existing art, the methods for amino acid nitrogen value adjustment are carried out by manual adding and mixing, resulting in low efficiency.

### SUMMARY

To overcome the defects of low efficiency in manual amino acid nitrogen value adjustment for soy sauce in the prior art, the aim of the invention is to provide a blending system for amino acid nitrogen value adjustment for soy sauce.

The blending system for amino acid nitrogen value adjustment for soy sauce according to the invention comprises a first soy-sauce tank, configured to receive first extracted soy sauce, and provided with a first circulation loop, and a second soy-sauce tank, configured to receive second extracted soy sauce, and provided with a second circulation loop, wherein, each of the first circulation loop and the second circulation loop is provided with an ammonia-nitrogen-value detection apparatus, and each of the first soy-sauce tank and the second soy-sauce tank is provided with an output tube with an output control valve connected to the ammonia-nitrogen-value detection apparatus, the output tubes of the first soy-sauce tank and the second soy-sauce tank are jointed and connected to a tube mixer. Two circulation loops are provided in the system of the invention, in which the first extracted soy sauce in the first soy-sauce tank and the second extracted soy sauce in the second soy-sauce tank are respectively circulated. By means of the mixing tube, the soy sauce from the first soy-sauce tank and the soy sauce from the second soy-sauce tank are mixed. The ammonia-nitrogen-value detection apparatuses are configured to measure the amino acid nitrogen values of the soy sauces that flow through the tubes, and the amino acid nitrogen values detected are compared with a target value set in the system for controlling the amino acid nitrogen values of the soy sauces, such that the soy sauce blending process of adjusting the amino acid nitrogen value is fully-automatic and intelligent, and its operation is simplified, resulting in an improved production efficiency and reduced labor force. Furthermore, with the system of the invention it is ensured that the finished soy sauce can satisfy the quality requirements on the amino acid nitrogen value.

As a further improvement to the foregoing technical solution, the system further comprises a mixing tank connected to an output end of the tube mixer. Further, two or more mixing tanks are provided. By means of the plurality of mixing tanks, the first extracted soy sauce and the second extracted soy sauce, which are respectively circulated, are mixed, wherein, while one of the mixing tanks is fed to a high level, another mixing tank may be activated to continue with the mixing, so as to maintain the continuity of the production process and further improve the blending efficiency.

As a further improvement to the foregoing technical solution, the mixing tank is a provided with a self-circulation loop, and the ammonia-nitrogen-value detection apparatus is arranged in the self-circulation loop. The soy sauces from the soy sauce tanks are thoroughly mixed through multiple circulations, the amino acid nitrogen value of the soy sauce mixed is regulated and stabilized, so as to facilitate an automatic blending and improve the production efficiency of soy sauce.

As a further improvement to the foregoing technical solution, the mixing tank is provided with a discharge tube with a finished product discharge valve connected to the ammonia-nitrogen-value detection apparatus. The ammonia-nitrogen-value detection apparatus is configured to measure the amino acid nitrogen value and salt content value of soy sauce that flows through the discharge tube. The amino acid nitrogen value and the salt content value detected are compared with target values set in the system, for amino acid nitrogen value control.

As a further improvement to the foregoing technical solution, the mixing tank is provided with a 360-degree-spraying pressure nozzle therein, spraying the mixed soy sauce in a pressurized manner into the mixing tank, to allow the soy sauce in the mixing tank to be mixed more uniformly and thoroughly.

As a further improvement to the foregoing technical solution, the mixing tank is provided with an upper-limit liquid-level gauge, a lower-limit liquid-level gauge, and a liquid-level detector. The upper-limit liquid-level gauge and the lower-limit liquid-level gauge are configured to detect the limit liquid levels in the mixing tank, and the liquid-level detector is configured to detect the continuous liquid level in the mixing tank, for monitoring the liquid level changes in real time.

As a further improvement to the foregoing technical solution, the self-circulation loop is provided with a finished product pump interlocked with the lower-limit liquid-level gauge. The finished-product pump is configured to pump out the finished soy sauce. While it is by the lower-limit liquid-level gauge detected that the liquid level in the mixing tank is lower than a lower-limit value, the finished-product pump is deactivated to cease the output, so as to prevent the finished-product pump from being damaged by dry pumping.

As a further improvement to the foregoing technical solution, the system further comprise a salt-adding apparatus disposed between the mixing tanks, comprising a powder mixer connected to the mixing tanks and provided with a salt scale-weighing jar with a conveyor auger. The salt scale-weighing jar is configured to feed salt into the powder mixer at a required amount of the salt to be added, by means of the conveyor auger, for pressurization, and the salt is mixed with the mixed soy sauces and fed into the mixing tanks.

As a further improvement to the foregoing technical solution, each of the first circulation loop and the second circulation loop is provided with a flow meter. The flow meter is configured to provide feedback of the discharge flow speed, so as to ensure that the discharge speed is a set average speed.

As a further improvement to the foregoing technical solution, each of the first soy-sauce tank and the second soy-sauce tank is provided with an upper-limit liquid-level gauge, a lower-limit liquid-level gauge, and a liquid-level detector. The upper-limit liquid-level gauges and the lower-limit liquid-level gauges are configured to measure the limit liquid levels in the first soy-sauce tank and the second soy-sauce tank, and the liquid-level detector is configured to measure continuous liquid levels in the first soy-sauce tank and the second soy-sauce tank, for monitoring liquid level changes in real time.

As a further improvement to the foregoing technical solution, each of the first circulation loop and the second circulation loop is provided with a discharge pump interlocked with the lower-limit liquid-level gauges. The discharge pumps is configured to deliver the blended soy sauce. While it is by the lower-limit liquid-level gauges detected that the liquid levels in the soy sauce tanks are lower than a lower-limit value, the discharge pumps are deactivated, so as to prevent the discharge pumps from being damaged by dry pumping.

As a further improvement to the foregoing technical solution, the system further comprises a first feed pump connected to a feed port of the first soy-sauce tank, and a second feed pump connected to a feed port of the second soy-sauce tank, wherein both of the first feed pump and the second feed pump are electrically connected to the upper-limit liquid-level gauges. The first feed pump and the second feed pump are configured to feed the first soy-sauce tank and the second soy-sauce tank, respectively. While it is by the upper-limit liquid-level gauge detected that the liquid level in the first soy-sauce tank or the second soy-sauce tank reaches an upper limit, the corresponding first feed pump or second feed pump is deactivated.

The invention further provides a process for adjusting amino acid nitrogen value with the blending system described above, comprising the following steps:

feeding the first extracted soy sauce into the first soy-sauce tank, activating the first circulation loop to thoroughly mix the soy sauce in the first soy-sauce tank during circulation, and detecting the amino acid nitrogen value of the soy sauce in the first soy-sauce tank by the ammonia-nitrogen-value detection apparatus, allowing the amino acid nitrogen value of the soy sauce in the first soy-sauce tank to be stabilized around 0.8 eventually;

feeding the second extracted soy sauce into the second soy-sauce tank, activating the second circulation loop to thoroughly mix the soy sauce in the second soy-sauce tank during circulation, and detecting the amino acid nitrogen value of the soy sauce in the second soy-sauce tank by the ammonia-nitrogen-value detection apparatus, allowing the amino acid nitrogen value of the soy sauce in the second soy-sauce tank to be eventually stabilized between 0.5 and 0.6; and opening the output control valves, to proportionally output the soy sauces from the first soy-sauce tank and the second soy-sauce tank, and to thoroughly mix the soy sauces in the tube mixer to obtain soy sauce having an amino acid nitrogen value between 0.7 and 0.75.

As a further improvement to the foregoing technical solution, the soy sauce mixed in the tube mixer is fed into the mixing tank, and the self-circulation loop of the mixing tank is activated to allow the amino acid nitrogen value of the soy sauce in the mixing tank to be eventually stabilized between 0.7 and 0.75.

As a further improvement to the foregoing technical solution, while the liquid level of the soy sauce in the mixing tank reaches 2 to 2.5 meters, the conveyor auger on the salt scale-weighing jar is activated to drop salt, the added salt is pressurized by a powder mixer and mixed with the mixed soy sauce from the mixing tank, and then a resulting mixture is fed into the mixing tank through the pressure nozzle.

With the blending system of the invention, by means of the circulation loop comprising the ammonia-nitrogen-value detection apparatus, fully-automatic and intelligent amino acid nitrogen value adjustment for soy sauce blending is achieved, and its operation is simplified, consequently the production efficiency is improved and the labor cost is reduced. Furthermore, with the system of the invention, the amino acid nitrogen value of soy sauce fully satisfies the quality requirements.

### BRIEF DESCRIPTION OF THE DRAWINGS

Further advantages and configurations are explained in more detail in the following text on the basis of preferred exemplary embodiments of the invention, and in conjunction with the accompanying drawings, in which:

FIG. 1 shows a schematic view of a system according to the invention;

FIG. 2 shows a schematic view of a first circulation loop according to the invention.

### DETAILED DESCRIPTION OF EMBODIMENTS

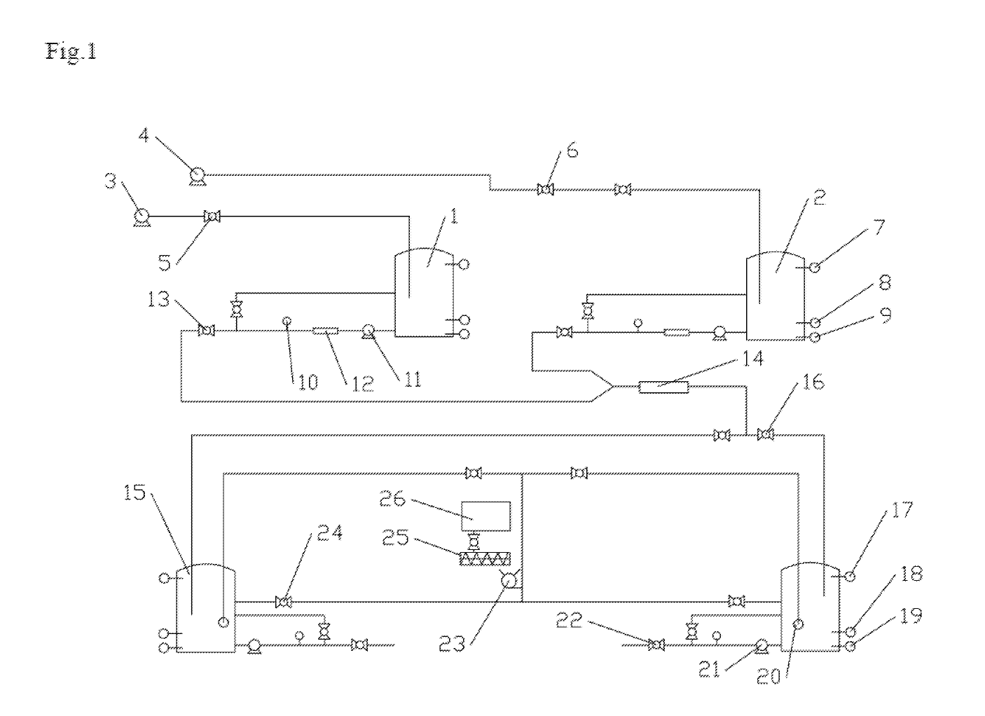

As shown in FIG. 1, according to an embodiment of the invention, a soy sauce blending system for amino acid nitrogen value adjustment comprises a first soy-sauce tank 1 configured to receive first extracted soy sauce and a second soy-sauce tank 2 configured to receive second extracted soy sauce. The first soy-sauce tank 1 and the second soy-sauce tank 2 are both made of glass fiber. The first soy-sauce tank 1 has a feed port through which the first soy-sauce tank 1 is connected to a first feed pump 3 for conveying the first extracted soy sauce, and a first feed valve 5 is arranged between the first feed pump 3 and the first soy-sauce tank 1. In a similar way, the second soy-sauce tank 2 has a feed port through which the second soy-sauce tank 2 is connected to a second feed pump 4 for conveying the second extracted soy sauce, and a second feed valve 6 is arranged between the second feed pump 4 and the second soy-sauce tank 2. Both of the first feed pump 3 and the second feed pump 4 are controlled in a Star-delta manner, and have stainless steel made pump bodies.

Each of the first soy-sauce tank 1 and the second soy-sauce tank 2 is provided with a blending upper-limit liquid-level gauge 7, a blending lower-limit liquid-level gauge 8, and a blending liquid-level detector 9 for detecting limiting liquid levels. Wherein, the blending upper-limit liquid-level gauge 7 in the first soy-sauce tank 1 is electrically connected to the first feed pump 3, and the blending upper-limit liquid-level gauge 7 in the second soy-sauce tank 2 is electrically connected to the second feed pump 4. When in the first soy-sauce tank 1 or the second soy-sauce tank 2, reaching of an upper-limit liquid level is detected by the blending upper-limit liquid-level gauge 7, the first feed pump 3 or the second feed pump 4 is shut off.

A first circulation loop is arranged in the first soy-sauce tank 1, and a second circulation loop is arranged in the second soy-sauce tank 2, each of the first circulation loop and the second circulation loop is provided with an ammonia-nitrogen-value detection apparatus 10 and a discharge pump 11. The discharge pump 11 is controlled by a frequency convertor, and has a stainless steel made pump body. A flow meter 12 is provided between the ammonia-nitrogen-value detection apparatus 10 and the discharge pump 11, providing feedbacks of discharge flow speed so as to ensure that the discharge speed is a set average speed. The discharge pump 11 configured to output blended soy sauce, is interlocked with the lower-limit liquid-level gauge 8, thus, when by the lower-limit liquid-level gauge it is detected that the liquid level in the soy sauce tanks is lower than a set lower-limit value, the discharge pump 11 is shut off, so as to prevent the discharge pump 11 from damage by “run dry”.

Each of the first soy-sauce tank 1 and the second soy-sauce tank 2 is provided with an output tube with an output control valve 13. The output tubes of the first soy-sauce tank 1 and the second soy-sauce tank 2 are jointed and consequently connected to a tube mixer 14. The output control valve 13 is connected to the ammonia-nitrogen-value detection apparatuses 10.

The tube mixer 14 at an output end thereof is connected to a mixing tank 15. Preferably, two or more mixing tanks 15 are provided. A blending discharge valve 16 is disposed between the tube mixer 14 and each of the mixing tanks 15. In this embodiment, two mixing tanks 15 are provided. Each of the mixing tanks 15 is provided with a mixing upper-limit liquid-level gauge 17, a mixing lower-limit liquid-level gauge 18, and a mixing liquid-level detector 19. Each of the mixing tanks 15 is further provided with a 360-degree-spraying pressure nozzle 20 arranged therein, which is spaced from the bottom of the mixing tank 15 about ⅓ of the height of the mixing tank 15. The mixed soy sauce is pressurized and sprayed into the mixing tanks 15, allowing the soy sauce to be mixed more uniformly and thoroughly therein. The two mixing tanks 15 are configured to respectively mix the first extracted soy sauce and the second extracted soy sauce that are separately circulated and blended. While one of the mixing tanks 15 is fed to a high level, the other one can be activated to continue with the mixing, therefore the production continuity is guaranteed and the blending efficiency is thus further improved.

A self-circulation loop is arranged on the mixing tank 15, comprising an ammonia-nitrogen-value detection apparatus 10 and a finished-product pump 21, wherein the finished-product pump 21 is interlocked with the mixing lower-limit liquid-level gauge 18. The mixing tank 15 is further provided with a discharge tube with a finished-product discharge valve 22 connected to the ammonia-nitrogen-value detection apparatus 10. The finished soy sauce product is outputted via the finished-product pump 21. When it is detected by the mixing lower-limit liquid-level gauge 18 that the liquid level in the mixing tank 15 is lower than a set lower-limit value, the finished-product pump 21 is shut off, so as to prevent the finished-product pump 21 from damage caused by dry pump. The ammonia-nitrogen-value detection apparatus 10 is configured to detect an amino acid nitrogen value and a salt content value of the soy sauce that flows through the discharge tube, and compare the amino acid nitrogen value and the salt content value detected with target values set in the system, for amino acid nitrogen value control.

A salt-adding apparatus is provided between two mixing tanks 15, comprising a powder mixer 23 connected to the mixing tank 15. The powder mixer 23 is connected to, at one end thereof the pressure nozzle 20, at the other end thereof a mixed soy sauce discharge port of the mixing tank 15. A pneumatic valve 24 is arranged in the mixed soy sauce discharge port. A mixing valve is provided between the powder mixer 23 and the pressure nozzle 20. A salt scale-weighing jar 26 with a conveyor auger 25 is provided on the powder mixer 23. A drop-salt vibration apparatus is provided in the salt scale-weighing jar 26. The salt scale-weighing jar 26 is configured to deliver the salt into the powder mixer 23 at a required salt-adding amount via the conveyor auger 25. The drop-salt vibration apparatus is activated during salt dropping. The added salt is pressurized by the powder mixer 23 and mixed with the mixed soy sauce. The resulting mixed soy sauce id fed into the mixing tank 15 through the pressure nozzle 20.

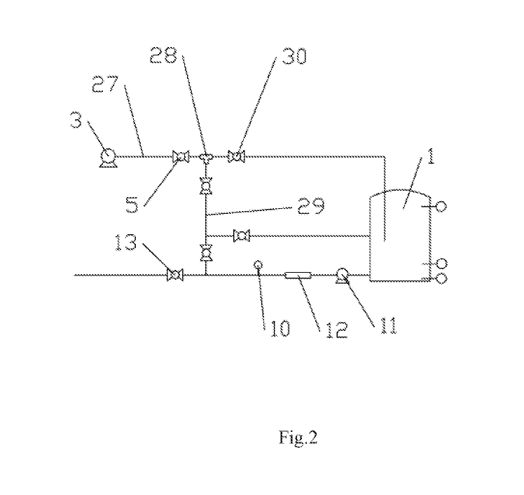

As shown in FIG. 2, the first circulation loop is illustrated as an example. In one of the structures of the circulation loop provided in the invention, a feed tube 27 is provided between the first feed pump 3 and the first soy-sauce tank 1, in which the first feed valve 5 is mounted. A transition tube 29 is connected between the first circulation loop and the feed tube 27, and a three-way valve 28 is provided at an outlet end of the first feed valve 5 and connected to the transition tube 29. A plurality of control valves 30 are provided and arranged, between the three-way valve 28 and the first soy-sauce tank 1, and on the transition tube 29, and on the first circulation loop. On account of the openings and closings of the respective control valves 30, the soy sauce in the first soy-sauce tank 1 can be circulated in the first circulation loop, or circulated in a pipe loop formed by the first circulation loop, the transition tube 29, and the feed tube 27, for longer circulation loop and more uniform mixing.

A soy sauce blending process for amino acid nitrogen value adjustment by means of the above described blending system comprises the following steps:

Open the first feed valve 5, and activate the first feed pump 3, to convey the first extracted soy sauce into the first soy-sauce tank 1; wherein, when by the blending liquid-level detector 9 it is detected that the liquid level in the first soy-sauce tank 1 reaches 2.5 m, activate the first circulation loop to thoroughly mix the soy sauce in the first soy-sauce tank 1 during circulation; continues to convey the first extracted soy sauce until by the blending upper-limit liquid-level gauge 7 it is detected that the liquid level in the first soy-sauce tank 1 reaches an upper-limit value of 6.5 m, shut off the first feed pump 3 and close the first feed valve 5; check the amino acid nitrogen value of the soy sauce in the first soy-sauce tank 1 by means of the ammonia-nitrogen-value detection apparatus 10, allowing the amino acid nitrogen value of the soy sauce in the first soy-sauce tank 1 to be eventually stabilized around 0.8.

Open the second feed valve 6 and activate the second feed pump 4 to convey second extracted soy sauce to a second soy-sauce tank 2; wherein, while it is by the blending liquid-level detector 9 detected that the liquid level in the second soy-sauce tank 2 reaches 2.5 m, activate the second circulation loop to thoroughly mix the soy sauce in the second soy-sauce tank 2 during circulation; continues to convey the second extracted soy sauce until it is by the blending upper-limit liquid-level gauge 7 detected that the liquid level in the second soy-sauce tank 2 reaches an upper-limit value of 6.5 m, shut off the second feed pump 4 and close the second feed valve 6; check the amino acid nitrogen value of the soy sauce in the second soy-sauce tank 2 by means of an ammonia-nitrogen-value detection apparatus 10, allowing the amino acid nitrogen value of the soy sauce in the second soy-sauce tank 2 to be eventually stabilized between 0.5 and 0.6.

While it is detected by the respective ammonia-nitrogen-value detection apparatuses 10 that the amino acid nitrogen and salt contents of the soy sauces both in the first soy-sauce tank and the second soy-sauce tank are stabilized in a certain range, the required amounts of the first extracted soy sauce, the second extracted soy sauce and the solid salt are calculated automatically by a computer according to indices of the amino acid nitrogen value and salt content of the first extracted soy sauce and the second extracted soy sauce, and thus the discharge time and speed of the first extracted soy sauce and the second extracted soy sauce are set. After that, the output control valves 13 are opened, the discharge pumps 11 are activated, and the flow meters 12 at the same time begin to add up flow amounts and provide feedbacks for the discharge speed. The soy sauces in the first soy-sauce tank 1 and in the second soy-sauce tank 2 are outputted in proportion and thoroughly mixed in the tube mixer 14 to obtain the soy sauce of an amino acid nitrogen value between 0.7 and 0.75. Once the accumulated flow amounts calculated by the flow meters 12 reach a required amount of the first extracted soy sauce and a required amount of the second extracted soy sauce for soy sauce blending, the discharge pumps 11 are shut off, and the output control valves 13 are closed.

While it is detected by the blending lower-limit liquid-level gauge 8 that the liquid level of the soy sauce in the first soy-sauce tank 1 or in the second soy-sauce tank 2 is lower than a lower-limit value, the discharge pump 11 is shut off for protection, preventing the discharge pump 11 from damage caused by dry pumping.

By opening the blending discharge valve 16 of one of the mixing tanks 15 and closing the blending discharge valve 16 of the other one of mixing tanks 15, an operator can feed the soy sauce mixed in the tube mixer 14 into the mixing tank 15. While it is by the mixing liquid-level detector 19 detected that the height of a liquid level in the mixing tank 15 reaches 2.5 m, a self-circulation loop of the mixing tank 15 is activated to ensure the amino acid nitrogen value of the soy sauce in the mixing tank 15 to be stabilized between 0.7 and 0.75 eventually. The conveyor auger 25 is activated at the same time. An initial weight and a final weight of salt addition are calculated by the salt scale-weighing jar 26 according to the present salt weight and a required salt-adding amount calculated by the computer. The drop-salt vibration apparatus is activated to drop salt at a frequency of 10 seconds per time. The pneumatic valve 24 is opened, solid salt is fed into the powder mixer 23 and is pressurized therein, and mixed with the soy sauce from the mixing tank 15, and then the mixture thereof is fed into the mixing tank 15 through the pressure nozzle 20. While it is by the blending high liquid-level gauge detected that the liquid level in the tank reaches 6.5 m, the feedings of the first extracted soy sauce and the feeding of the second extracted soy sauce are stopped. While it is by the ammonia-nitrogen-value detection apparatus 10 on the self-circulation loop detected that the amino acid nitrogen and salt content of the mixed soy sauce meet index requirements and stay stable, the finished-product discharge valve 22 is opened and the self-circulation loop is deactivated, the finished product begins to be outputted, until it is by the mixing lower-limit liquid-level gauge 18 detected that the liquid level in the mixing tank 15 is lower than a lower-limit value, at that time the finished-product pump 21 is shut off to halt the output. After that, the current soy sauce blending process is completed, the system is ready for a next blending process.

When the finished soy sauce is circulated and blended in one of the mixing tanks 15, by closing the blending discharge valve 16 connected to the mixing tank 15 and opening the blending discharge valve 16 connected to another mixing tank 15, the other one of the mixing tanks 15 can be brought into mixing, so as to ensure the production continuity and thus further improve the blending efficiency.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A blending system for amino acid nitrogen value adjustment for soy sauce, comprising:
a first soy-sauce tank, configured to receive first extracted soy sauce, and provided with a first circulation loop, and
a second soy-sauce tank, configured to receive second extracted soy sauce, and provided with a second circulation loop;
wherein, each of the first circulation loop and the second circulation loop is provided with an ammonia-nitrogen-value detection apparatus, and each of the first soy-sauce tank and the second soy-sauce tank is provided with an output tube with an output control valve connected to the ammonia-nitrogen-value detection apparatus, the output tubes of the first soy-sauce tank and the second soy-sauce tank are jointed and connected to a tube mixer.

2. The blending system according to claim 1, further comprising a mixing tank connected to an output end of the tube mixer.

3. The blending system according to claim 2, wherein two or more mixing tanks are provided.

4. The blending system according to claim 2, wherein the mixing tank is a provided with a self-circulation loop, and the ammonia-nitrogen-value detection apparatus is arranged in the self-circulation loop.

5. The blending system according to claim 4, wherein the mixing tank is provided with a discharge tube with a finished product discharge valve connected to the ammonia-nitrogen-value detection apparatus.

6. The blending system according to claim 2, wherein the mixing tank is provided with a 360-degree-spraying pressure nozzle therein.

7. The blending system according to claim 2, wherein the mixing tank is provided with an upper-limit liquid-level gauge, a lower-limit liquid-level gauge, and a liquid-level detector.

8. The blending system according to claim 7, wherein the self-circulation loop is provided with a finished product pump interlocked with the lower-limit liquid-level gauge.

9. The blending system according to claim 2, further comprising a salt-adding apparatus disposed between the mixing tanks, wherein the salt-adding apparatus comprises a powder mixer connected to the mixing tanks and provided with a salt scale-weighing jar with a conveyor auger.

10. The blending system according to claim 1, wherein each of the first circulation loop and the second circulation loop is provided with a flow meter.

11. The blending system according to claim 1, wherein each of the first soy-sauce tank and the second soy-sauce tank is provided with an upper-limit liquid-level gauge, a lower-limit liquid-level gauge, and a liquid-level detector.

12. The blending system according to claim 11, wherein each of the first circulation loop and the second circulation loop is provided with a discharge pump interlocked with the lower-limit liquid-level gauges.

13. The blending system according to claim 11, further comprising a first feed pump connected to a feed port of the first soy-sauce tank, and a second feed pump connected to a feed port of the second soy-sauce tank, wherein both of the first feed pump and the second feed pump are electrically connected to the upper-limit liquid-level gauges.

14. A process for adjusting amino acid nitrogen value with the blending system according to claim 1, comprising the following steps:
feeding the first extracted soy sauce into the first soy-sauce tank, activating the first circulation loop to thoroughly mix the soy sauce in the first soy-sauce tank during circulation, and detecting the amino acid nitrogen value of the soy sauce in the first soy-sauce tank by the ammonia-nitrogen-value detection apparatus, allowing the amino acid nitrogen value of the soy sauce in the first soy-sauce tank to be stabilized around 0.8 eventually;
feeding the second extracted soy sauce into the second soy-sauce tank, activating the second circulation loop to thoroughly mix the soy sauce in the second soy-sauce tank during circulation, and detecting the amino acid nitrogen value of the soy sauce in the second soy-sauce tank by the ammonia-nitrogen-value detection apparatus, allowing the amino acid nitrogen value of the soy sauce in the second soy-sauce tank to be eventually stabilized between 0.5 and 0.6; and
opening the output control valves, to proportionally output the soy sauces from the first soy-sauce tank and the second soy-sauce tank, and to thoroughly mix the soy sauces in the tube mixer to obtain the soy sauce having an amino acid nitrogen value between 0.7 and 0.75.

15. The process according to claim 14, wherein, the soy sauce mixed in the tube mixer is fed into the mixing tank, and the self-circulation loop of the mixing tank is activated to allow the amino acid nitrogen value of the soy sauce in the mixing tank to be eventually stabilized between 0.7 and 0.75.

16. The process according to claim 15, wherein, while the liquid level of the soy sauce in the mixing tank reaches 2 to 2.5 meters, the conveyor auger on the salt scale-weighing jar is activated to drop salt, the added salt is pressurized by a powder mixer and mixed with the mixed soy sauce from the mixing tank, and then a resulting mixture is fed into the mixing tank through the pressure nozzle.
